(19) United States
(12) Patent Application Publication
(10) Pub. No.: US 2010/0253062 A1
(43) Pub. Date: Oct. 7, 2010

(54) BANKNOTE WITH EDGE WINDOWS

(75) Inventors: Bruce Hardwick, Victoria (AU); John Taylor, New South Wales (AU)

Correspondence Address: BARNES & THORNBURG LLP, 750-17TH STREET NW, SUITE 900, WASHINGTON, DC, 20006-4675, US

(73) Assignee: SECURENCY INTERNATIONAL PTY LTD, Craigeburn ,Victoria (AU)

(21) Appl. No.: 12/742,328

(22) PCT Filed: Nov. 5, 2008
(86) PCT No.: PCT/AU2008/001641

§ 371 Date: Jun. 14, 2010

(30) Foreign Application Priority Data
Nov. 13, 2007 (AU) 2007906224

(51) Int. Cl. B42D 15/10; B42D 15/00; B31D 1/00

(52) U.S. Cl. 283/94; 283/110; 493/374

(57) ABSTRACT

A security document comprising a sheet having a front surface, a rear surface and sides edges. The sheet includes one or more windows or half-windows formed from a transparent or translucent material. At least one of the windows or half-windows is an edge window or half-window which extends to at least one side edge region of the sheet, and the edge window or half-window includes one or more of the following features: a denominator; an independent security device; and/or a trigger feature.

### FIELD OF THE INVENTION

This invention relates to security documents, and is particularly concerned with providing a security document or token with at least one enhanced security device or feature.

### DEFINITIONS

### Security Document

As used herein the term security documents includes all types of documents and tokens of value and identification documents including, but not limited to the following: items of value such as banknotes, credit cards, cheques, passports, identity cards, securities and share certificates, driver's licenses, deeds of title, travel documents such as airline and train tickets, entrance cards and tickets, birth, death and marriage certificates, and academic transcripts.

The invention is particularly applicable to foldable or flexible security documents such as banknotes formed from a substrate to which one or more layers of printing are applied.

Substrate

As used herein, the term substrate refers to the base material from which the security document or token is formed. The base material may be paper or other fibrous material such as cellulose; a plastic or polymeric material including but not limited to polypropylene (PP), polyethylene (PE), polycarbonate (PC), polyvinyl chloride (PVC), polyethylene terephthalate (PET); or a composite material of two or more materials, such as a laminate of paper and at least one plastic material, or of two or more polymeric materials.

The use of plastic or polymeric materials in the manufacture of security documents pioneered in Australia has been very successful because polymeric banknotes are more durable than their paper counterparts and can also incorporate new security devices and features. One particularly successful security feature in polymeric banknotes produced for Australia and other countries has been a transparent area or “window”. Other manufacturers of paper and paper/polymer laminated substrates for security documents have recognised the potential of windows as a security feature and are now developing ways to incorporate them into such substrates.

Transparent Windows and Half Windows

As used herein the term window refers to a transparent or translucent area in the security document compared to the substantially opaque region to which printing is normally applied. The window may be fully transparent so that it allows the transmission of light substantially unaffected, or it may be partly transparent or translucent partially allowing the transmission of light but without allowing objects to be seen clearly through the window area.

A window area may be formed in a polymeric security document which has least one layer of transparent polymeric material and one or more opacifying layers applied to at least one side of a transparent polymeric substrate, by omitting least one opacifying layer in the region forming the window area. If opacifying layers are applied to both sides of a transparent substrate a fully transparent window may be formed by omitting the opacifying layers on both sides of the transparent substrate in the window area.

A partly transparent or translucent area, hereinafter referred to as a “half-window”, may be formed in a polymeric security document which has opacifying layers on both sides by omitting the opacifying layers on one side only of the security document in the window area so that the “half-window” is not fully transparent, but allows some light to pass through without allowing objects to be viewed clearly through the half-window. Half-windows allow lower or buried layers or features on the opacified side to be seen clearly from the other side.

Alternatively, it is possible for the substrates to be formed from an substantially opaque material, such as paper or fibrous material, with an insert of transparent plastics material inserted into a cut-out, or recess in the paper or fibrous substrate to form a transparent window or a translucent half-window area. Also the substrate may be formed from a paper/plastics laminate with a portion of the paper cut out or otherwise removed to form a window.

Opacifying Layers

Opacifying layers applied to a transparent substrate may comprise any one or more of a variety of opacifying coatings. For example, the opacifying coatings may comprise a pigment, such as titanium dioxide, dispersed within a binder or carrier of heat-activated cross-linkable polymeric material. Alternatively, a substrate of transparent plastic material could be sandwiched between opacifying layers of paper or other substantially opaque material to which indicia may be subsequently printed or otherwise applied.

Security Device or Feature

As used herein the term security device or feature includes any one of a large number of security devices, elements or features intended to protect the security document or token from counterfeiting, copying, alteration or tampering. Security devices or features may be provided in or on the substrate or by deforming the substrate of the security document or in or on one or more layers applied to the base substrate, and may take a variety of forms. The two main types of security devices provided in banknotes and other security devices are overt security devices and covert security devices.

Overt Security Devices

Overt security devices are those which are apparent to a person handling the banknote and include devices such as security threads embedded in layers of the security document and visible at least in transmission when a person holds the security document up to the light; printed features which are visible in reflection and/or transmission; embossed features, including relief structures, which may be tactile so that they can be detected by a person feeling the tactile area of the note; and optically variable devices (OVDs). OVDs provide an optically variable effect when the banknote is tilted and/or when the viewing angle of the observer relative to the OVD changes. An OVD may be provided by a printed area, eg an area printed with metallic inks or iridescent inks, by an embossed area, and by a combination of a printed and embossed feature. An OVD may also be provided by a diffractive device, such as a diffraction grating or a hologram.

Covert Security Devices

A covert security device is one which is not apparent to a person handling the banknote without the use of external verification or authentication means. Covert security devices include features such as microprinting, which requires a magnifying lens to authenticate the microprinting; and features formed by photoluminescent inks and phosphorescent inks which require illumination by electromagnetic radiation of a particular wavelength, eg infra-red (IR) or ultra-violet (UV) radiation, for the ink to luminesce or phosphoresce; and photochromic, thermochromic, hydrochromic or piezochromic inks.

Trigger Feature

A “trigger feature” is a feature (or combination of features) which alerts a recipient of a security document such as a banknote, that the document is genuine. A Trigger feature is learnt from the experience of handling notes and while it is derived from one or a number of features in combination it is a feature in its own right. Trigger features are based around one of the primary senses such as feel. Once the Trigger feature has alerted the recipient to the fact that the document may not be genuine, the overt security features within the document are usually more closely perused. Such overt features may include the trigger feature(s) itself.

Denominator Feature

A denominator is a feature which enables a person to identify the denomination or value of the security document, for example whether a banknote represents the value of $5, $10 or $20 etc. Some security features function both as trigger features and denominators. For example, Australian banknotes are printed in a range of bright colours with $5 notes in a purple colour, $10 notes in a blue colour, $20 in a red colour, $50 notes in a yellow colour and $100 notes in a green colour. The different bright colours in the currency range for Australian banknotes provide an instant trigger feature and also enable a person instantly to identify the denomination of the banknote by a visual check.

Diffractive Optical Elements (DOEs)

As used herein, the term diffractive optical element (DOE) refers to a numerical-type diffractive optical projection element. Numerical-type diffractive optical elements (DOEs) rely on the mapping of complex data that reconstruct in the far field (or reconstruction plane) a two-dimensional intensity pattern. When substantially collimated light, e.g. from a point light source or a laser, is incident upon the DOE, an interference pattern is generated that produces a projected image in the reconstruction plane that is visible when a suitable viewing surface is located in the reconstruction plane, or when the DOE is viewed in transmission at the reconstruction plane. The transformation between the two planes can be approximated by a fast Fourier transform (FFT). Thus, complex data including amplitude and phase information has to be physically encoded in the micro-structure of the DOE. This DOE data can be calculated by performing an inverse FFT transformation of the desired reconstruction (i.e. the desired intensity pattern in the far field). DOEs are sometimes referred to as computer-generated holograms, but they differ from other types of holograms, such as rainbow holograms and volume phase holograms. A DOE may be an overt security device insofar as an effective point light source of white light, such as a spot light commonly found in many supermarkets and buildings, can be used to provide the substantially collimated light for viewing the DOE simply by holding it up to the light, or a DOE may be a covert security device requiring a monochromatic point light source, such as a laser or light emitting diode (LED) for verification. W099/37488 discloses various methods of authenticating a security document provided with a diffractive optical projection element (DOE), in a window.

Self-Verifying Security Documents

Another security feature that has been proposed in connection with security documents with windows is the combination of a verification window at one location of a banknote and a security element verifiable at another, laterally spaced location of the banknote. For example, the verification window may contain a colour filter for viewing a covert security element in the form of an area printed with metameric inks at the laterally spaced location as disclosed in W098/15418. However, neither the verification window, nor the covert security element constitutes a security device which functions independently as an overt security device without a complementary security device or verification element.

### BACKGROUND OF THE INVENTION

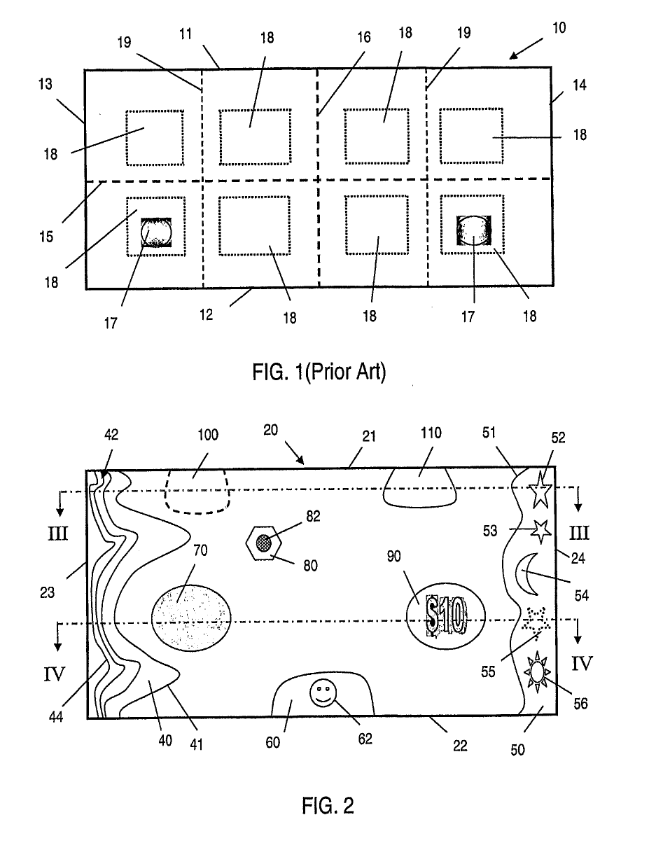

Polymeric banknotes incorporating windows or half windows have been successfully produced in Australia and several other countries for a number of years. However, polymeric banknote producers and designers have imposed several limitations on the physical location of windows within the note as will be explained with reference to FIG. 1.

FIG. 1 is a schematic plan view of a banknote 10 comprising an oblong rectangular flexible sheet having opposed longer side edges 11, 12 and opposed shorter side edges 13, 14. The sheet has a major central longitudinal axis 15 extending parallel to its longer side edges 11, 12 and a minor central transverse axis 16 extending parallel to its shorter side edges. The banknote 10 is provided with two self-verifying windows 17 each comprising a polarising window with one window 17 having a polarisation axis perpendicular to the polarisation axis of the other window 17. The polarising windows form a relatively simple self verification system and are located such that when the banknote is folded about the central transverse axis 16, the polarising windows 17 are superimposed with their polarisation axes perpendicular to extinguish the transmission of light through the polarising windows. Hitherto, banknote designers have restricted the location of windows to certain regions 18 of a banknote as shown in FIG. 1 for a number of reasons. First, it has been believed that for optimum processing, many banknote processing machines require an opaque area at a leading side edge in order that the start of a banknote can be identified and the banknote can then be tracked as it passes through the processing machine. The leading side edge is usually one or both of the shorter side edges 13, 14, but it is also possible for a leading side edge to be a longer side edge 11, 12. Also, the use and location of window areas has been restricted by the belief that certain sensors in banknote processing machines will treat window areas as holes. Further, there is an assumed restriction that windows should not be located on central major and minor axes 15, 16 or even on quarter transverse lines 19 because these commonly serve as fold lines, not only for self-verifying security documents as illustrated by FIG. 1, but also when banknotes are folded by the general public for other purposes. If a window or half-window area contains a security device such as a diffraction grating, hologram or diffractive optical element (DOE), then such security devices have been thought to deteriorate more due to wear if located on or near to one of the main fold lines 15,16 of the banknote.

The restrictions discussed above have limited the surface area of the banknote within which windows or half-windows have been located to as little as 25% of the total surface area of the note. These restrictions have made polymer banknotes more vulnerable to the casual counterfeiter and less useful to certain members of the community than would be the case if the banknote designer could position windows or half windows in a wider range of areas of the note.

Canadian patent application CA 2 294 755 A1 discloses a self-verifying security document which has a verification element formed by at least one window and a security feature integrated into the document at different positions of the document whereby the verification element are only superimposed when verification takes place. Thus, the security element is a covert security device which is only revealed when the verification element is superimposed over the security element, eg by folding the banknote, and the verification element does not function itself as an overt security device independently of the security element. CA 2294755 A1 mentions that the verification element may be embodied as a strip along one of the edges of the document, or one corner of the document may be embodied as a verification element. However, there is no disclosure as to how a verification window can actually be formed as a strip along a side edge or at a corner of the document.

A commemorative £5 polymer banknote was issued by the Northern Bank of Northern Ireland in 1999, featuring a transparent window on each of its longer edges, the windows including a simple printed line design representing the Earth as a transparent coloured disc. However, the line design within the windows does not provide any additional difficulty to a counterfeiter wishing to copy the document over the window itself.

It is therefore desirable to provide the banknote designer with the freedom to position windows or half windows in a wide range of areas of a banknote.

It is also desirable to provide a security document, such as a banknote, with at least one window and which is more difficult to counterfeit than if the window is restricted to a small size and a small range of locations on the document.

It is further desirable to provide a security document, such as a banknote, which contains at least one security device that is easier to verify by certain members of the public.

### SUMMARY OF THE INVENTION

According to one aspect of the invention, there is provided a foldable security document comprising a sheet having a front surface, a rear surface and side edges, the sheet including one or more windows or half-windows formed from a transparent or translucent material, wherein at least one of the windows or half-windows is an edge window which extends to at least one side edge region of the sheet, and said edge window includes one or more of the following features:

a denominator;

an independent security device;

and/or a trigger feature.

According to a second aspect of the invention, there is provided a foldable security document comprising an oblong rectangular sheet having a front surface, a rear surface, longer side edges and shorter side edges, the sheet including a plurality of windows or half-windows formed from a transparent or translucent material, wherein the sheet has at least one edge window or half-window which is provided on at least one shorter side edge of the sheet, and the at least one edge window includes one or more of the following features: a denominator; an independent security device; and/or a trigger feature. According to another aspect of the invention, there is provided a method of manufacturing a foldable security document comprising the steps of:

providing a sheet of material having a front surface, a rear surface and side edges;

providing the sheet with at least one region of transparent or translucent material forming a window or half-window in such a manner that at least one of the windows or half-windows is an edge window or half-window which extends to at least one side edge of the sheet; and

providing said edge window with one or more of the following features: a denominator; an independent security device and/or a trigger feature.

There is a distinct advantage in providing a security device and/or denominator and/or a trigger feature in an edge window or half-window as opposed to an internal location of a banknote, in that it is the area of the banknote most likely to be first handled during a transaction and it is the area of a banknote involved in hand counting.

Also for the visually impaired it means that they do not have to search the internal region of the banknote to locate the denominator. This increases the speed with which a decision on denomination can be made which adds to the independence of the visually impaired.

Preferably, the security document is oblong rectangular in shape having opposite longer sides and opposite shorter sides. At least one side window may be provided on at least one of the longer sides, but preferably the document has at least one side edge window or half-window provided along at least one of shorter side edges, and more preferably has at least one side edge window or half-window provided on opposite side edges of the sheet forming the security document. At least one of the side edge windows or half windows may extend completely along a respective side edge, or a plurality of side edge windows may be provided on a side edge.

At least one of the edge windows may include a feature which serves as at least two of the functions of a security device, a denominator and a trigger feature. For example, tactile features could serve as a security device and/or denominator and a trigger feature. An advantage of providing a banknote with a tactile feature in a window on at least one shorter side edge is that banknotes are usually handed to a recipient with one of the shorter edges leading. In addition most, if not all approaches to hand counting involves the short edge. A further advantage is that it reduces the area which needs to be examined. By providing different tactile features on a plurality of currency notes of different denominations with each tactile feature corresponding to respective denomination, it is also possible for the tactile feature to serve as a denominator for the visually impaired. Preferably tactile features are provided in edge windows on both opposite shorter side edges of a banknote so that the recipient can ascertain the presence of a tactile feature whichever shorter side edge is handled. A further advantage of providing tactile features in windows on shorter side edges of banknotes is that it reduces the pressure on banknote manufacturers from organisations for the visually impaired to provide banknotes of different shapes, eg with cropped or rounded corners, or to provide banknotes with notches, holes or the like.

An overt or tactile security feature, trigger feature or denominator in an edge window or half-window may be provided by at least one embossing on said edge window or half window. Alternatively, or additionally, an overt or tactile security device, trigger feature or denominator may be provided by a raised printed area on the edge window or half-window, and/or by a coating or coatings, which have tactile properties in defined areas, eg tackiness or abrasiveness

In another preferred embodiment, an edge window or half-window may be provided with an optically variable security device or OVD. An OVD may take a variety of different forms, but is preferably provided by one or more of the following:

a printed area, eg an area printed with metallic inks or iridescent inks;

an embossed area;

a combination of a printed and embossed feature; and/or

a diffractive device, such as a diffraction grating or a hologram.

A security document, such as a banknote, provided with at least one edge window extending to a side edge of the sheet, is more difficult to counterfeit than a banknote with a window provided at an internal location spaced from the side edges of the sheet. It helps to avoid the method employed by casual counterfeiters involving cutting out or punching a hole in a sheet and covering the hole with a transparent material, such as a transparent adhesive tape of cellophane or other plastic material. Although incidences of counterfeiting of Australian polymeric banknotes have been much lower than in other countries which use traditional paper banknotes, about 95% of counterfeits of polymeric notes have been produced by this unsophisticated “punch and seal” technique which is relatively easy to detect. However, if an edge window is provided, the casual counterfeiter has more difficulty in punching a hole at a side edge of a sheet, and then has to apply the transparent adhesive tape or other plastic material to cover the hole very carefully so that the edge of the transparent adhesive tape is closely in register with the remaining part of the side edge. If the whole of a side edge is a window area, then a counterfeiter must simulate the physical properties of a genuine window and a counterfeit with transparent adhesive tape is easy to detect, and if a transparent film is used by the counterfeiter, then a large join is required to the remainder of the note making detection easier. A plurality of edge windows or a side edge can also add difficulty to counterfeiters.

The substrate is preferably formed from at least one layer of transparent polymeric material with at least one opacifying layer applied to at least one side of the transparent polymeric substrate, with at least one opacifying layer omitted in the at least one edge region forming the edge window or half-window area.

In one preferred embodiment, opacifying layers are applied to opposite sides of the substrate with the opacifying layers on both sides of the substrate omitted in one region to form a transparent window in the security documents.

In another preferred embodiment, at least one opacifying layer is applied to one side of the transparent substrate to completely cover said one side, and at least one opacifying layer is applied to the opposite side of the substrate, except in a region which forms the half-window area.

In the case of a half-window in which the transparent region is covered on one side by at least one opacifying layer, a security device may be a reflective device which is only visible in the half-window from the opposite side of the substrate, which is not covered by an opacifying layer in the half-window area.

It is also possible for the opacifying layer, which covers the half-window area on one side of the substrates, to allow the partial transmission of light so that the security device is partially visible in transmission from the side, which is covered by the opacifying layer in the half-window area.

In another embodiment, the security device in the edge window or half-window may be a composite security device containing two or more different security elements.

The security document may also include a verification means for verifying another security feature provided on the document.

In the case of a half-window the security feature may be provided on the opposite side of the substrate from the verification means and in register with the verification means, so that the verification means is permanently superimposed over the security feature.

In the case of a flexible security document, such as a bank note or the like, which is foldable, if the verification means is provided in a full window area, the security feature may be provided on another part of the document which is laterally spaced from the verification means, whereby the security feature is only verifiable when the verification means is superimposed over the security feature, e.g. by folding.

Some preferred embodiments of the present invention will now be described, by way of example only, with reference to the accompanying drawings, in which:

FIG. 1 is a schematic plan view of a prior art security document;

FIG. 2 is a schematic plan view of a security document in accordance with one aspect of the invention;

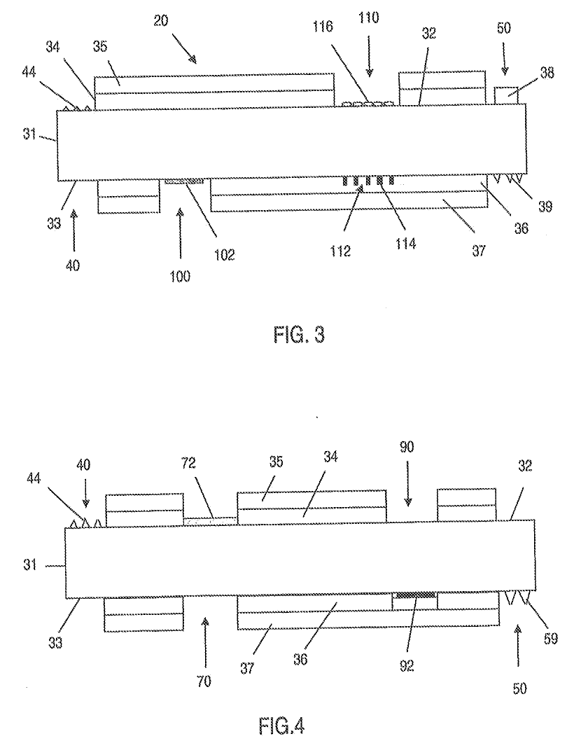

FIG. 3 is a schematic section through the security document on the line III-III of FIG. 1;

FIG. 4 is a schematic section through the security document on the line IV-IV of FIG. 1.

Referring to FIG. 2 there is shown an elongate rectangular security document 20, in particular a banknote, having two longer side edges 21, 22 and two shorter side edges 23, 24. The banknote 20 has a plurality of windows 40, 50, 60, 70 and 80, and half-windows 90, 100 and 110 provided at various locations of the note. Each of the windows contains at least one respective trigger feature, denominator or security device, 42, 52, 62, 72, 82, 92, 102 and 112.

As shown in FIGS. 3 and 4, the banknote comprises a substrate 31 of transparent or translucent plastic materials having a first, upper surface 32 and a second, lower surface 33. The transparent substrate is preferably formed from a transparent polymeric material such as a laminated structure of two or more layers of bi-axially oriented polypropylene. It will, however, be appreciated that other transparent polymeric substrates may be used in the present invention such as polyethylene and polyethyleneterephthalate (PET).

Opacifying layers 34, 35; and 36, 37 are applied respectively to the first and second surfaces 32 and 33 of the transparent or translucent substrate 31 with one or more of the opacifying layers 34, 35, 36, 37 omitted in various regions of the substrate to form the window or half-window areas 40, 50, 60, 70, 80, 90,100, 110 in which the security devices 42, 52, 62, 72, 82, 92, 102, 112 are provided.

The opacifying layers 34, 35, 36 and 37 may comprise any one or more of a variety of opacifying coatings. For example, the opacifying coatings may be layers of opacifying inks, eg comprising a pigment, such as titanium dioxide, dispersed within a binder or carrier of heat-activated cross-linkable polymeric material. Alternatively, the substrate 11 of transparent plastic material could be sandwiched between opacifying layers of paper to which indicia may be subsequently printed or otherwise applied. The outer surfaces of opacifying layers 35 and 37 of the banknote may be printed with indicia.

As shown in FIGS. 2 to 4, the windows 40 and 50 are edge windows extending completely along the shorter side edges 23, 24 of the banknote. In these side edge regions the opacifying layers 34, 35, 36 and 37 are omitted on both surfaces of the transparent or translucent substrate 31. The edge window 40 is provided with a tactile feature 42 in the form of a series of embossed lines 44 on the first surface 32 of the substrate 31. The edge window 50 is provided with a plurality of security devices 52, 53, 54, 55, 56 which may take a number of different forms. For example, the security device 52 in the shape of a star shown in FIG. 2 may be a security device or vignette formed by a printed area and/or embossed area on one or both surfaces of the substrate 31. As shown in FIG. 3, there is a printed area 38 on the first, upper surface 32 and an embossing 39 on the second, lower surface 33 of the substrate 31. The printed area 36 may be formed from at least one opacifying coating of the same type as opacifying coatings 34 to form a vignette in the required shape within the window 50. Alternatively, the first surface 32 may be printed with a different type of ink to form the vignette. Preferably, the ink or coating forming the vignette has a different feel than the smoother texture of the surrounding area of the transparent or translucent surface of the substrate to form a tactile security feature 52. The tactility of the security device 52 may be enhanced by the embossing 39 on the second surface 33 of the substrate 31. The embossing 39 may be a raised line or a groove in the shape of the outline of the security device 52, and/or it could be a series of lines within the perimeter of the device 52.

Similarly, the other security devices 53, 54, 55 and 56 may be formed from printed and/or embossed areas on one or both surfaces of the substrate 31 forming shapes or designs within the window 50. For instance, the star design 55 is formed solely from a blind embossing 59 on the second surface 33 of the substrate 31. The moon and sun designs 54 and 56 shown in FIG. 2 may be printed in one or more coloured inks with or without embossings.

As shown in FIG. 2, the borders 41 and 51 of the shorter side edge windows 40 and 50 are of irregular shapes, and the embossings lines 44 and 39 of security devices 42 and 52 are also of an irregular shape. The shape of the shorter side edge windows 40, 50 and/or the embossings 42, 52 may vary for different denominations of banknotes in a currency series so that the shorter side edge windows 40, 50 themselves and/or the embossings 44, 39 may serve as denominators for the visually impaired. They may also serve as a trigger feature or first check of authenticity in the areas likely to be felt first by a recipient in a transaction involving the banknote. Areas of varying tactility may be provided in edge windows in a variety of ways, including areas of opacifying coatings, areas of film, areas of raised printed indicia, areas of a transparent or translucent overcoat and embossed areas.

The banknote shown in FIGS. 2 and 3 also includes an edge window 60 at a central location on its longer side edge 22 and two edge windows in the form of half windows 100, 110 on its other longer side edge 21. The edge window 60 is a full window and includes a security device 62. The security device 62 may comprise any of a number of different security devices, including: an area printed with a security ink, such as a fluorescent, luminescent or phosphorescent ink, a metallic ink, an iridescent ink, a photochromic, thermochromic, hydrochromic or piezochromic ink; other printed and/or embossed features, including vignettes and relief structures; an interference layer; a liquid crystal device; a lens or lenticular structure; or an optically variable device (OVD) such as a diffraction grating or hologram. The edge windows 100 and 110 are half windows on opposite surfaces of the substrate 31 as shown in FIG. 3 by omitting the opacifying coatings 34, 35 on the first, upper surface 32 to form half window 110, and by omitting the opacifying coatings 36, 37 on the second, lower surface 33 to form the half window 100. Each of the half windows 100,110 includes a respective security device 102, 112 which may take any convenient form, including: an area printed with a security ink, such as a fluorescent, luminescent or phosphorescent ink, a metallic ink, an iridescent inks, a photochromic, thermochromic, hydrochromic or piezochromic ink; other printed and/or embossed features, including vignettes and relief structures; an interference layer; a liquid crystal device; a lens or lenticular structure; or an optically variable device (OVD) such as a diffraction grating or hologram. As shown in FIG. 3, the security device 102 in half window 100 is provided on the second, lower surface 33 which is not covered by the opacifying coatings 36, 37. The security device 112 in half window 110 may include an element 114 provided on the second, lower surface 33 of the substrate 31 which is covered by the opacifying coatings 36, 37 so that can be viewed through the transparent substrate 31 from the opposite side of the banknote. The security device 112 in half window 110 may include at least one reflective security element 114 which is visible from one side of the security document, i.e. the side corresponding to the first, upper surface of the substrate 31 to which the opacifying layers 34, 35 are partially applied. The security device 112 may be either completely invisible or partially visible from the opposite side of the substrate 31, depending upon the thickness and opacity of the opacifying layers 36, 37 which are applied to the second, lower surface 32 of the substrate 31.

In another preferred embodiment, the security element 114 in half window 110 may comprise microprinting or an array of microimages, with a lens structure 116, such as a magnifying lens or an array of microlenses formed on the first, upper surface 32 of the substrate 31 for viewing the security element 114. With an array of microlenses and an array of microimages, it is possible to obtain a variety of visual effects, such as a Moire magnified image, moving and/or floating images.

Additional layers may applied to the opacifying layers 34, 35, 36 and 37. The layers 34 and 35 may be additional opacifying layers, e.g. pigmented coatings containing titanium dioxide when it is desired to increase the opacity of the security document except in the half-window areas 100,110. Alternatively, the additional layers 34 and 35 may be layers of printed indicia.

Any of the security devices in the edge windows or half windows 40, 50, 60, 100, 110 may be provided in the substrate 31, itself, and/or in, or between layers that make up the substrate or security document. For example, the substrate 31 and/or an opacifying layer 34, 35, 36, 37 may include an upconverting (Anti-Stokes) material which produces radiation of a high energy when illuminated with electromagnetic radiation of a lower energy. The security device(s) in the substrate and/or opacifying layer(s) is preferably localised in the particular area of at least one of the edge windows.

FIG. 4 is a sectional view showing a verification window 70 for inspecting a security device 92 in a half-window 90 at a laterally spaced location of the banknote. The arrangement of the verification window 70 and the security device 92 in half window 90 is such that when the bank note is folded about the central fold line so that the verification window 70 is superimposed over the half window 90 , the security device 92 becomes visible so that the authenticity of the bank note can be verified.

For example, the security device 92 in the half window 90 may be in the form of an inspectable element, such as a dichroic feature, eg an image printed from metameric inks, and the verification element 72 in the window 70 may be in the form of a filter, eg a colour filter, an interference filter or a diffractive or holographic filter. Dichroic features and metameric inks have the unique property of appearing to change colour when viewed in different lighting conditions or in different spectral environments. For example, two inks with different metameric properties may appear to be an identical colour when viewed in a particular white light environment, e.g. day light, but when viewed in different lighting conditions, e.g. in filtered light, the two inks will appear to have different reflective colours so that one ink appears in a colour distinguishable from the other.

The verification element 72 in window 70 and the security element 92 in half window 90 are located at laterally spaced locations on the banknote and are arranged so that when the banknote is folded about the central fold line, the verification element 72 is superimposed over the further security feature, and the colour changing properties of the security element 92 become apparent when the metameric image is viewed through the verification element 72 in the form of the filter. The security element 92 printed with metameric inks may be a permanent image which appears a single colour when viewed in ambient light, with part of the image appearing a different colour from the remainder of the image when the filter of the verification element 72 is superimposed over the further security feature. Alternatively, it is possible for the security element 92 to be a latent image which becomes visible when viewed through the filter of the verification element 72 when the banknote 20 is folded to superimpose the verification element 72 over the security device. Although it may be possible for the verification element 72 of the window 70 to be in the form of a colour-tinted filter or interference filter, preferably the verification element 72 comprises a holographic or diffractive filter which can provide a clearer or sharper image when verifying the image of the further security feature.

It will be appreciated that the combination of a verification element in the form of a filter and a dichroic or metameric security device are not the only types of verification elements and security devices which may be provided in a self-verifying security document. Other types of verification elements include polarising windows, liquid crystal coatings, lenticular structures, etc. For example, a verification element in the form of a lens or array of microlenses may be used to inspect a security device in the form of microprinting or microimages in similar manner to that described above. It will also be appreciated that a verification element and/or an inspectable security device may be provided in one or more edge windows. For example, a verification window could be provided at the location of edge window 100 with the security element inspectable by the verification window provided in an edge window at the location of window 110.

FIG. 2 also shows a further window 80 which includes an inspectable security element 82 in the form of a numerical-type diffractive optical element (DOE). Numerical-type diffractive optical elements (DOEs) rely on the mapping of complex data that reconstruct in the far field (or reconstruction plane) a two-dimensional intensity pattern. Thus, when substantially collimated light, e.g. from a point light source or a laser, is incident upon the DOE, an interference pattern is generated that produces a projected image in the reconstruction plane that is visible when a suitable viewing surface is located in the reconstruction plane, or when the DOE is viewed in transmission at the reconstruction plane. The transformation between the two planes can be approximated by a fast Fourier transform (FFT). Thus, complex data including amplitude and phase information has to be physically encoded in the micro-structure of the DOE. This DOE data can be calculated by performing an inverse FFT transformation of the desired reconstruction (i.e. the desired intensity pattern in the far field). The security device 82 may be a transmissive device, such as a transmission DOE which produces a projected image in the remote reconstruction plane when viewed in transmission with collimated light from a point light source or a laser. In another embodiment, when a metallic ink is used, a layer of metallic ink applied to the transparent region of the substrate may be sufficiently thin to allow the transmission of light to enable a transmission DOE to be formed.

Although the window 80 including the DOE is provided internally of the edges of the banknote, it will be appreciated that an edge window could be provided with a DOE as a security element.

It will be appreciated that various modifications and alterations may be made to the embodiments of the present invention described above without departing from the scope and sprit of the present invention. For example, whilst the embodiments above have been described with particular reference to a security document in the form of a banknote, it will be appreciated that the various aspects and embodiments of the invention have application to other types of security and identification documents including, but not limited to the following: credit cards, cheques, passports, identity cards, securities and share certificates, driver's licenses, deeds of title, travel documents such as airline and train tickets, entrance cards and tickets, birth, death and marriage certificates, and academic transcripts.

Any references to prior patent specifications or any other prior art in this specification, whether in the definitions, background section or otherwise is not, and should not be taken as an acknowledgement that such prior art forms part of the common general knowledge in Australia or any other country.

1. A foldable security document comprising a sheet having a front surface, a rear surface and side edges, the sheet including one or more windows or half-windows formed from a transparent or translucent material, wherein at least one of the windows or half-windows is an edge window or half-window which extends to at least one side edge region of the sheet, and said edge window or half-window includes one or more of the following features: a denominator ; an independent security device; and/or a trigger feature.

2. A foldable security document according to any one of the preceding claims wherein the sheet is oblong rectangular having longer sides and shorter sides, and the sheet has at least one side edge window provided on at least one of its shorter side edges.

3. A foldable security document comprising an oblong rectangular sheet having a front surface, a rear surface, longer side edges and shorter side edges, the sheet including a plurality of windows or half-windows formed from a transparent or translucent material, wherein the sheet has at least one edge window or half-window which is provided on at least one shorter side edge of the sheet, and the at least one edge window or half-window includes one or more of the following features: a denominator; an independent security device; and/or a trigger feature.

4. A foldable security document according to claim 2 or claim 3 wherein the sheet has edge windows or half-windows provided on both its shorter side edges.

5. A foldable security document according to any one of the preceding claims wherein at least one of the side edge windows extends completely along a side edge.

6. A foldable security document according to any one of the preceding claims wherein the sheet has a plurality of side edge windows provided on at least one of its side edges.

7. A foldable security document according any one of the preceding claims wherein the edge window or half-window includes an overt security device and/or a denominator and/or a trigger feature.

8. A foldable security document according to any one of the preceding claims wherein the edge window or half-window includes a tactile security device and/or a denominator and/or a trigger feature.

9. A foldable security document according to any one of the preceding claims wherein said security device is provided at least partly by at least one embossing on said edge window or half-window.

10. A foldable security document according to any one of the preceding claims wherein said security device includes a raised printed area on said edge window or half window.

11. A foldable security document according to any one of the preceding claims wherein said security device includes a coating or coatings, which have tactile properties in defined areas on said edge window or half window.

12. A foldable security document according to any one of the preceding claims wherein said security device is an optically variable device (OVD).

13. A foldable security document according to claim 12 wherein the OVD is provided by any one or more of the following:
a printed area, eg an area printed with metallic inks or iridescent inks; an embossed area;
a combination of a printed and embossed feature; and
a diffractive device, such as a diffraction grating or a hologram.

14. A foldable security document according to any one of the preceding claims wherein at least one edge window includes a diffractive optical element (DOE).

15. A foldable security document according to any one of the preceding claims wherein the edge window includes a lens structure which is superimposed over a security feature including at least one microimage.

16. A foldable security document according to claim 15 wherein the lens structure comprises an array of microlenses and the security feature comprises an array of microimages.

17. A foldable security document according to any one of the preceding claims wherein the sheet comprises a substrate formed from at least one layer of transparent or translucent material and at least one opacifying layer applied to at least one surface of the transparent or translucent material, wherein the at least one opacifying layer is omitted in the edge region or regions forming the window or half-window area or areas.

18. A foldable security document according to claim 17 wherein opacifying layers are applied to opposite surfaces of the transparent or translucent substrate with the opacifying layers on both surfaces of the substrate omitted in at least one of said region or regions to form a transparent or translucent window in the foldable security document.

19. A foldable security document according to claim 17 wherein at least one opacifying layer is applied to one surface of the substrate to cover said one surface except in an edge region which forms a half-window area and at least one opacifying layer is applied to the opposite surface of the substrate in said edge region.

20. A foldable security document according to any one of claims 17 to 19 wherein the transparent or translucent substrate is formed from a plastics material selected from one or more of the following: a polymer such as polypropylene (PP); polyethylene (PE); polyethylene terephthalate (PET); polyvinyl chloride (PVC); or cellulose.

21. A foldable security document according to any one of claims 17 to 20 wherein the at least one opacifying layer comprises a layer of opacifying ink.

22. A foldable security document according to any one of claims 17 to 20 wherein the at least one opacifying layer comprises a substantially opaque layer of paper or fibrous material.

23. A foldable security document according to any one of claims 17 to 22 wherein at least one edge window includes a security device provided in the substrate and/or in at least one opacifying layer.

24. A foldable security document according to any one of the preceding claims wherein the document is a banknote.

25. A method of manufacturing a foldable security document comprising the steps of:
providing a substrate of transparent or translucent plastics material;
applying opacifying layers on opposite sides of the substrate;
omitting at least one of the opacifying layers on at least one side of the substrate in at least one region to form a window or half-window area;
wherein at least one of the opacifying layers is omitted in at least one side edge region of the substrate to form at least one edge window or half-window; and
providing at least one feature which functions as a denominator and/or as an independent security device and at least one feature which functions as a trigger feature in said at least one edge window.

26. A method according to claim 25 wherein the security device in said at least one edge window is a security feature which functions independently as an overt security device.

27. A method according to claim 25 or claim 26 wherein the security feature is a tactile security device.

28. A method according to claim 27 wherein the tactile security device is provided by embossing the substrate in the side edge region on said edge window or half-window.

29. A method according to any one of claims 25 to 28 wherein said security device includes a raised printed area on said edge window or half-window.

30. A method according to any one of claims 25 to 29 wherein the edge window or half-window includes a security device provided in the edge region by any one or more of the following:
a printed area, eg an area printed with metallic inks or iridescent inks;
an embossed area;
a combination of a printed and embossed feature; and
a diffractive device, such as a diffraction grating or a hologram.

31. A, method according to any one of claims 25 to 30 wherein the substrate comprises an oblong rectangular sheet having a front surface, a rear surface, longer side edges and shorter side edges, and the at least one opacifying layer is omitted in opposite side edge regions to form window or half-windows in opposite side edges of the sheet.
